(19) United States
(12) Patent Application Publication
(10) Pub. No.: US 2009/0099491 A1
(43) Pub. Date: Apr. 16, 2009

(54) HEMORRHOID TREATMENT DEVICE

(76) Inventor: Jiro TAKASHIMA, Houston, TX (US)

Correspondence Address: EGBERT LAW OFFICES, 412 MAIN STREET, 7TH FLOOR, HOUSTON, TX, 77002, US

(21) Appl. No.: 12/341,975

(22) Filed: Dec. 22, 2008

Related U.S. Application Data
(63) Continuation-in-part of application No. 11/130,827, filed on May 17, 2005.

(51) Int. Cl. A61H 7/00

(52) U.S. Cl. 601/137

(57) ABSTRACT

The hemorrhoid treatment device has a head and a shaft. The head has a spherical shape which is between 6 and 14 millimeters in diameter. The shaft has a cylindrical shape extending from the head. The minimum length of the shaft is 30 mm. The surface area of the head is equal to the surface area of a portion of the shaft. The portion of the shaft is defined from a portion adjacent to the head and 1.5 cm to 3.5 cm from the head.

### CROSS-REFERENCE TO RELATED APPLICATIONS

The present application is a continuation-in-part of U.S. patent application Ser. No. 11/130827, filed on 17 May 2005, and entitled “Hemorrhoid Treatment Device”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a hemorrhoid treatment device. More particularly, the present invention relates to devices for massaging internal and external hemorrhoids by self movement of the device. The present invention also relates to devices that are held within the anal canal and are driven by the peristaltic activity of the surface of the anal canal for the purpose of massaging internal and external hemorrhoids.

2. Description of Related Art Including Information Disclosed Under 37 CFR 1.97 and 37 CFR 1.98.

Prior art technology in the field of hemorrhoid treatment relies upon application of a device inserted into the anal canal. Several devices are retained within the anal canal by manual application, such that the user inserts and removes the device by hand. The frequency and depth of medicine applied to the anal canal is controlled by the hand of the user. Other devices are retained within the anal canal without additional assistance. The principle of the function of those devices are to stride the anal canal. The devices are mechanically positioned across the muscle of the anal canal, having ends to physically lock the device in place.

For example, in U.S. Pat. No. 3,777,755, issued to Groves on Dec. 11, 1973, the device is formed by nut-and-bolt-like construction, having two huge bulbs connected by a thin shaft. The device discloses a range of bulb sizes and shaft diameters. The bulbs stride the anal canal to prevent any motion of the device through the anal canal, such that there is no consideration given to maintaining a bulb within the anal canal. The proportional sizes vary between embodiments of the bulbs and shaft shown. No particular weight is given to any embodiment as long as the larger locking end bulbs of the device lock across the anal canal.

U.S. Design Pat. No. D428,488, issued to Bloch on Jul. 18, 2000, shows a first ball and second ball connected by a shaft. The device has a shaft with a diameter proportionally large to the length. Furthermore, the diameter of the shaft is not much smaller than the diameter of either ball. There is no disclosure of other proportions or diameters of either the shaft or balls.

The prior art has several drawbacks. In particular, the nut-and-bolt-like construction cannot maintain the device in the anal canal without manual intervention. The user must mechanically place the device in the anal canal and remove the device from the anal canal for each application of medicine. Any massaging action to the internal hemorrhoids can only be achieved by manually controlling the device in and out of the anal canal. Also, an end of the device remains outside of the anal canal. At least one of the locking bulbs protrude from the anus, which prevents discrete use of the device.

The prior art discloses a range of ball diameters, shaft diameters and shaft lengths through illustrations and without numerical ranges. The physical dimensions can vary along any length or diameter, according to the comfort of the individual, as long as the two ends are locked across the anal canal. The anal canal is an active part of anatomy. The anal canal has gripping ability to grasp and hold objects therein by lateral rectal pressure and an involuntary evacuative feature byperistaltic activity. The elimination of human waste is provided by the evacuative functions, and the gripping ability provides for bowel control. The anal canal cannot expel the prior art device through evacuative functions, and the anal canal cannot grip or close with an end ball protruding therefrom. The prior art devices avoid interaction with the anal canal because the devices are mechanically locked across the anal canal.

It is an object of the present invention to provide a hemorrhoid treatment device interactive with the anal canal.

It is an object of the present invention to provide a hemorrhoid treatment device maintained in the anal canal by peristaltic activity and lateral rectal pressure only.

It is another object of the present invention to provide a hemorrhoid treatment device for massaging internal and external hemorrhoids.

It is further object of the present invention to provide a hemorrhoid treatment device that is easy to use, easy to manufacture and relatively inexpensive.

These and other objects and advantages of the present invention will become apparent from a reading of the attached specification and appended claims.

### BRIEF SUMMARY OF THE INVENTION

A hemorrhoid treatment device consisting of a head having a spherical shape, and a shaft connected to the head. The shaft has a generally cylindrical surface extending from the head. The diameter of the shaft is smaller than the diameter of the head. The head and shaft have physical dimensions to achieve the unexpected result of maintaining the device in the anal canal through interaction with the anal canal. For example, the diameter of the head ranges between 6 mm and 14 mm. Also, the maximum diameter of the shaft is 20% of the length within the anal canal, the shaft having a minimum length of 30 mm. The surface area of the head is equal to the surface area of the shaft adjacent to the head at 1.5 cm to 3.5 cm from the head. The device has only a single head at one end of the shaft.

### BRIEF DESCRIPTION OF THE SEVERAL VIEWS OF THE DRAWINGS

FIG. 1 is a side elevational view of the hemorrhoid treatment device of the present invention.

FIG. 2 is a schematic view, illustrating the hemorrhoid treatment device of the present invention as located at a first position in the anal canal.

FIG. 3 is another schematic view, illustrating the hemorrhoid treatment device of the present invention as located at a second position in the anal canal.

### DETAILED DESCRIPTION OF THE INVENTION

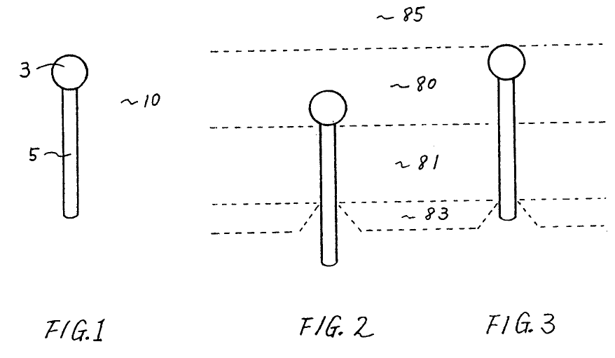

FIG. 1 shows the hemorrhoid treatment device 10 of the present invention. The device 10 interacts with the anal canal through rectal lateral pressure and peristaltic movement of the anal canal.

The device 10 has a head 3, with a shaft 5 connected to the head 3. The head 3 has a generally spherical shape. The shaft 5 is generally cylindrical. The head 3 and shaft 5 have physical dimensions to achieve the unexpected result of maintaining the device 10 in the anal canal through interaction with the anal canal. The diameter of the head 3 ranges between 6 mm and 14 mm. Also, the maximum diameter of the shaft is 20% of the length within the anal canal, the shaft having a minimum length of 30 mm. The surface area of the head is equal to the surface area of the shaft adjacent to the head at 1.5 cm to 3.5 cm from the head. The device has only a single head at one end of the shaft. The preferred material of the device is a rigid or a semi-rigid material. The semi-rigid materials can be of a soluble material.

As shown in FIGS. 2 and 3, the working principle of the device 10 inside the anal canal is demonstrated. The main components of the anal canal are the internal hemorrhoid area 80, the pecten 81 and the subcutaneous external sphincter 83. The pecten 81 is characterized by a narrow passage wall having a two-way valve function. The subcutaneous external sphincter 83 contains the external hemorrhoid. Above the internal hemorrhoid area 80 is the ampulla of the rectum 85. Anatomically, the range of sizes of the main components are: 12 to 18 mm for the internal hemorrhoid area; 12 to 18 mm for the pecten; and 5 to 10 mm for external sphincter.

FIG. 2 shows the device 10 in use. As inserted into the anal canal, the head 3 reaches the upper portion of the pecten 81. The pecten 81 has a two-way valve function. Lateral rectal pressure exerted by the pecten 81 forces the head 3 upward to the internal hemorrhoid area 80 until the head 3 reaches the ampulla of the rectum 85. As the head 3 moves upward, the shaft 5 makes more contact with the pecten 81 in FIG. 3. Peristaltic movement inside the pecten 81 pulls downward on the shaft 5 as the evacuative function, balancing the upward pressure. The device 10 is maintained in the anal canal for application of medicine on the shaft. The two-way valve function of the pecten 81 interacts with the device 10 having sufficient surface area on the head 3 for the lateral rectal pressure and sufficient surface area on the shaft for peristaltic evacuative functions. The user may control the massaging by engaging and releasing lateral rectal pressure so that the device 10 moves up and down in the anal canal.

The present invention provides a hemorrhoid treatment device interactive with the anal canal. Unlike the prior art, the device 10 treats hemorrhoids without manual control and locked placement astride the anal canal. Additionally, only the peristaltic activity and lateral rectal pressure of the anal canal controls the placement and movement of the device 10. The device 10 can massage internal and external hemorrhoids.

These inherent physical dimensions of the head 3 and shaft 5 can be affected to cause the unexpected results of maintaining the device 10 in the anal canal with only peristaltic activity and lateral rectal pressure. The range of the maximum diameter of the shaft is 20% of the length within the anal canal for the shaft, with a minimum shaft length of 30 mm, is inventive beyond the prior art. The diameter of the shaft must be in a proportional relationship to the length within the anal canal in order to insure that the lateral rectal pressure can be applied. If the diameter is to proportionally large, then the pecten cannot grip, and there will be no upward movement. A hemorrhoid treatment device without this proportion will be involuntarily evacuated from the anal canal by peristaltic movement. This diameter proportion range is shown by some illustrations in the prior art, in particular the Groves Patent, but there is no suggestion or even indication that such a range is significant. The unexpected result of losing lateral rectal pressure was not possessed or disclosed by the prior art. There is no indication of any special diameter range within the prior art disclosure. Furthermore, the prior art mechanically locked across the anal canal, such that the affect upon lateral rectal pressure was not even a consideration of the prior art. The present invention now claims such a limitation.

Similarly, the range limitation is that the surface area of the head 3 must be equal to the surface area of the shaft 5 adjacent to the head at 1.5 cm to 3.5 cm from the head. The device 10 has a single head 3 without a second ball or bulb at the other end. Thus, the shaft 5 interaction with the anal canal must be sufficient for the peristaltic evacuative function to balance the lateral rectal pressure on the head 3. The shaft 5 inherently has a diameter, and the prior art shows a wide range of diameters. In the present invention, the limitation is that the portion of the shaft 5 directly adjacent to the head 3 must have a surface area equal to the surface area of the head 3, wherein the portion is defined by 1.5 cm to 3.5 cm from the head 3. This surface area insures that the lateral rectal pressure and the peristaltic movement is balanced. Outside of this range, the device would be pushed into the rectum or expelled through the sphincter. This range is not made obvious by the prior art disclosure of various shapes and sizes.

These range limitations of inherent physical features of elements of the present invention are not anticipated nor made obvious by the prior art. The particular size and proportion relationships are not disclosed by the figure illustrations of prior art. There is no understanding or possession of the inventive concepts of the present hemorrhoid treatment device in the prior art. The possible disclosure of non-scaled illustrations does not make the present invention obvious. There are unexpected results of the limitations in the claims of the present invention.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A hemorrhoid treatment device maintained within an anal canal and interactive with said anal canal, the device comprising:
a unitary body consisting of a head and shaft, said head being connected to one end of a shaft and having a generally spherical shape, said shaft having a generally cylindrical shape, said shaft having a diameter less than 20% of the length of said shaft, said head having a surface area equal to a surface area of a portion of said shaft adjacent said head and between 1.5 cm to 3.5 cm from said head.

2. The device of claim 1, wherein said head had a maximum diameter between 6 mm and 14 mm inclusive.

3. The device of claim 2, said shaft having a constant diameter.

4. The device of claim 1, said unitary body being formed of a polymeric material.

5. The device of claim 1, said shaft having a minimum length of 3 cm.
